(19) United States
(12) Patent Application Publication
(10) Pub. No.: US 2012/0032064 A1
(43) Pub. Date: Feb. 9, 2012

(54) METHOD AND APPARATUS FOR A BWR JET PUMP SUPPORT SYSTEM

(75) Inventors: Michael S. Defilippis, Wilmington, NC (US); James P. Carneal, Wilmington, NC (US); Norbert Wroblewski, West Bloomfield, MI (US)

(73) Assignee: GE-HITACHI NUCLEAR ENERGY AMERICAS LLC, Wilmington, NC (US)

(21) Appl. No.: 12/850,218

(22) Filed: Aug. 4, 2010

(51) Int. Cl. F16B 2/02

(52) U.S. Cl. 248/675

(57) ABSTRACT

A method and apparatus for applying a lateral restraining force to a diffuser or an inlet mixer of a Boiling Water Reactor (BWR) jet pump restrainer assembly, to pull the diffuser or inlet mixer toward a centerline of a riser pipe. The lateral restraining force may be applied to just a diffuser, or just an inlet mixer, or both. Clamps are attached to the diffuser or inlet mixer, and alternatively to the riser pipe, and draw bolts are connected to the clamps to provide the necessary restraining force. The lateral restraining force either mitigates damage and repair to a conventional jet pump restrainer assembly, or alternatively is used in lieu of a jet pump restrainer assembly.

### BACKGROUND OF THE INVENTION

1. Field of the Invention

Example embodiments relate generally to nuclear reactors, and more particularly to a method and apparatus for a Boiling Water Reactor (BWR) jet pump support system for mitigating vibratory movement of the inlet mixers, diffusers and riser pipe.

2. Related Art

A reactor pressure vessel (RPV) of a boiling water reactor (BWR) typically has a generally cylindrical shape and is closed at both ends (for example by a bottom head and a removable top head). A top guide typically is spaced above a core plate within the RPV. A core shroud, or shroud, typically surrounds the core and is supported by a shroud support structure. Particularly, the shroud has a generally cylindrical shape and surrounds both the core plate and the top guide. There is a space or annulus between the cylindrical reactor pressure vessel and the cylindrically shaped shroud.

In a BWR, hollow tubular jet pumps positioned within the shroud annulus provide the required reactor core water flow. The upper portion of the jet pump, known as the inlet mixer, is laterally positioned and may be supported by conventional jet pump restrainer assemblies. While conventional jet pump restrainer brackets may provide system stiffness that mitigates vibration of the inlet mixers, diffusers and riser pipe, the restrainer brackets sometimes require costly repair and downtime of the jet pump assembly. Specifically, formation of set screw gaps and wear between the conventional restrainer bracket, the main wedge of the restrainer bracket, and the guide rod require machining and/or replacement of these parts throughout the operational life of the jet pump assembly.

Additionally, movement of the inlet mixer relative to the diffuser can be caused by leakage flow between the inlet mixer and the diffuser. This behavior is typically celled slip joint flow induced vibration. The slip joint flow induced vibrations occur anytime that oscillating pressure forces are greater than the forces constraining the inlet mixer and diffuser. Methods for preventing this vibration include either eliminating the leakage flow, sufficiently constraining the inlet mixer and diffuser, or a combination of reducing the leakage flow and constraining the inlet mixer and diffuser.

### SUMMARY OF INVENTION

Example embodiments provide a method and an apparatus for providing a lateral restraining force (i.e., additional side loading) on the jet pump restrainer assembly diffuser and/or the diffuser and inlet mixer to increase Boiling Water Reactor (BWR) jet pump assembly system stiffness. The lateral restraining force may push the diffusers and inlet mixers toward the centerline of the riser pipe to prevent slip joint flow induced vibration, reduce the formation of set screw gaps, and mitigate damage to conventional restrainer assembly brackets, wedges, and guide rods. The lateral restraining force may be easy to install, and may be used in conjunction with conventional jet pump restrainer assemblies, or alternatively in lieu of conventional jet pump restrainer assemblies.

Because the additional lateral restraint provided by this disclosure may be used in lieu of using a conventional main wedge, it is sometimes advantageous to remove the wedge from operation (without entirely removing the main wedge from the conventional restrainer bracket), while implementing the example embodiments described herein. Removal of the main wedge from operation may be accomplished via the use of a jet pump main wedge clamp, as described in the General Electric Hitachi application “METHOD AND APPARATUS FOR A BWR JET PUMP MAIN WEDGE CLAMP,” Attorney Docket No. 24NS243873 (HDP #8564-000208/US).

The additional lateral restraint and side loading provided by this disclosure may also put undue strain on set screws of a conventional restrainer bracket. Therefore, it may be advantageous to provide redundant rigid support for the inlet mixer (to counteract the forces being placed on the inlet mixer being applied by this invention), while implementing the example embodiments described herein. Redundant rigid support for the inlet mixer may be accomplished through the use of an inlet mixer support, such as the one described in the General Electric Hitachi application “METHOD AND APPARATUS FOR A BWR JET PUMP INLET MIXER SUPPORT,” Attorney Docket No. 24NS243875 (HDP #8564-000209/US).

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1A is a perspective view of a conventional boiling water reactor (BWR) nuclear reactor jet pump assembly;

FIG. 1B is a detailed view of a conventional BWR jet pump restrainer assembly;

FIG. 2 is a detailed view of a BWR jet pump support system, in accordance with example embodiments;

FIG. 3 is a perspective view of a BWR jet pump support system being used on a jet pump assembly, in accordance with example embodiments;

FIG. 4 is a detailed view of a BWR jet pump support system with optional contact supports, in accordance with example embodiments;

FIG. 5 is a perspective view of a BWR jet pump support system with optional contact supports being used on a jet pump assembly, in accordance with example embodiments;

FIG. 6 is a detailed view of a simplified BWR jet pump support system, in accordance with example embodiments;

FIG. 7 is a perspective view of a simplified BWR jet pump support system used on a jet pump assembly, in accordance with example embodiments;

FIG. 8 is a detailed view of an optional inlet mixer support system, in accordance with example embodiments;

FIG. 9 is a perspective view of an optional inlet mixer support system used on a jet pump assembly, in accordance with example embodiments; and

FIG. 10 is a perspective view of a BWR jet pump support system and optional inlet mixer support system used on a jet pump assembly, in accordance with example embodiments.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

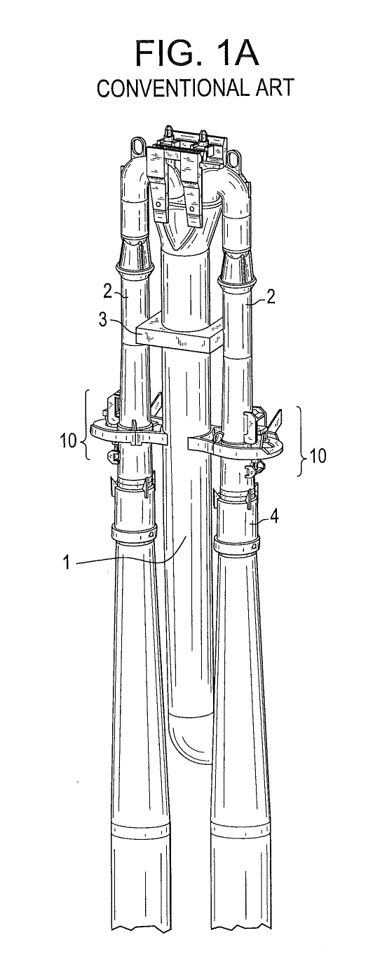

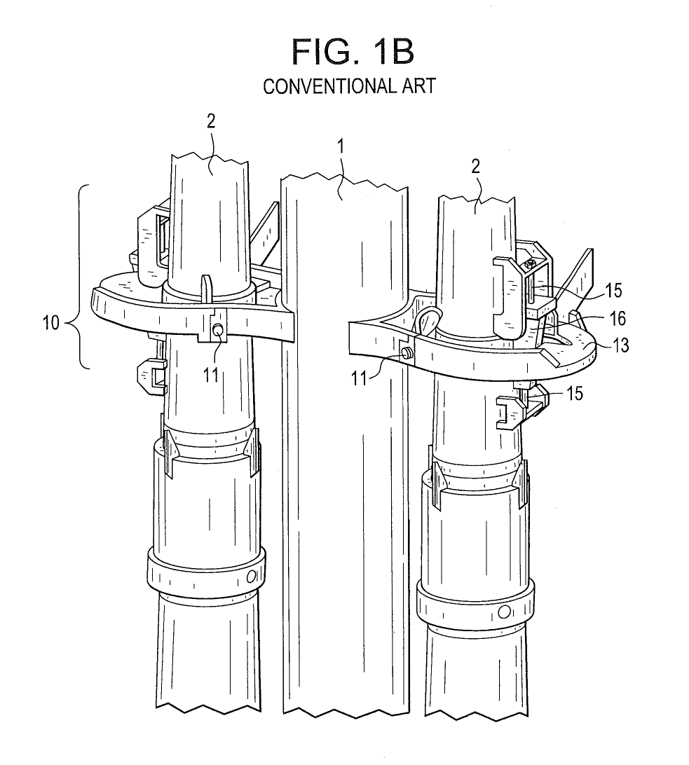

Referring to FIG. 1A, a perspective view of a conventional Boiling Water Reactor (BWR) nuclear reactor jet pump assembly is depicted. The jet pump assembly includes conventional jet pump restrainer assemblies 10 attached to the riser pipe 1. The jet pump restrainer assemblies 10 stabilize any movement of the inlet mixers 2 relative to the riser pipe 1 while the jet pump assembly is in use.

FIG. 1B is a detailed view of a conventional BWR jet pump restrainer assembly 10. Each restrainer assembly 10 includes a restrainer bracket 13 with three points of contact (two set screws 11, and one main wedge 16) to stabilize vibratory movement of an inlet mixer 2. The main wedge 16 is a gravity wedge riding on a wedge rod 15 that pushes inlet mixer 2 toward a centerline of the riser pipe and up against two sets of set screws 11 to reduce movement of the inlet mixers 2 when a BWR jet pump assembly is operating. Conventionally, set screw gaps may form during operation (an undesirable space is formed between the inlet mixer 2 and the set screws 11), causing vibration and damage between the inlet mixer 2 and the set screws 11. Additionally, vibration of the jet pump assembly may cause the wedge rod 15 to become damaged or worn and wear between the restrainer bracket 13 and wedge rod 15 may also occur. All of this wear may cause costly repair and downtime of the jet pump assembly.

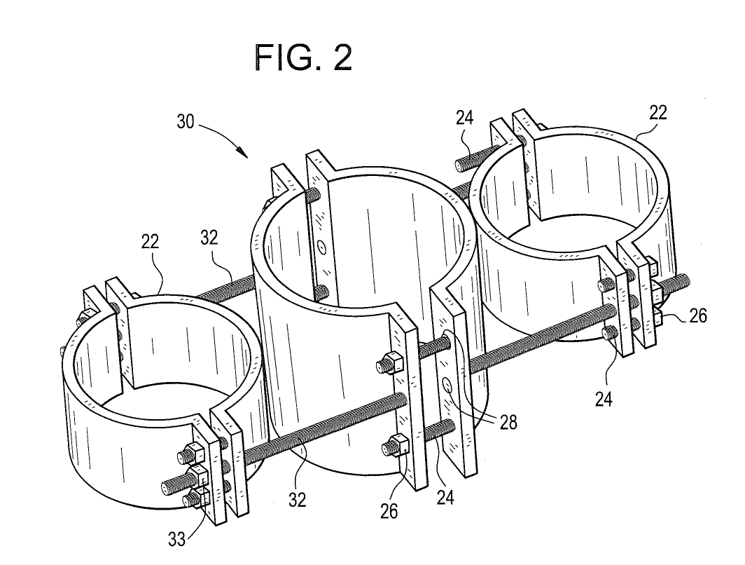

FIG. 2 shows a detailed view of a BWR jet pump support system 30, in accordance with example embodiments. The support system 30 may include a riser pipe clamp 20 that may be fitted to a riser pipe 1 of a BWR jet pump assembly. The support system 30 may also have diffuser clamps 22 that may be fitted to diffusers 4 of a jet pump assembly. The clamps 20/22 may be provided with bolts 24 and nuts 26 to affix the clamps 20/22 to the riser pipe 1 and diffuser 4 of a jet pump assembly. The clamps may include eyelits 28 which may be penetration points on each cuff of clamps 20/22, providing a means by which the bolts 24/nuts 26 may be used to easily affix the clamps on a jet pump assembly.

Draw bolts 32 may be provided in order to provide the actual lateral restraining force for the support system 30. Draw bolts 32 may be provided in both the front and the rear of the support system 30. The draw bolt 32 may include one long bolt that may be affixed to both diffuser clamps 22 and the riser pipe clamp 20. Alternatively, a smaller draw bolt 32 may be provided that is affixed to the riser pipe clamp 20 and one of the diffuser clamps 22, and a separate draw bolt 32 may be provided that is affixed to the riser pipe clamp 20 and the other diffuser clamp 22. Draw bolts 32 may be affixed to the diffuser clamps 22 and riser pipe clamps 20 by penetrating clamp eyelits 28 in the clamps and being secured via draw bolt nuts 33. The draw bolts 32 may be threaded bolts that mate with threaded eyelit connections 28. Alternatively, draw bolts 32 may be attached to the riser pipe clamp 20 and diffuser clamps 22 via other means such as welding, spot welding, hooks, clamping devices, or any other means to securely fasten the draw bolts 32 to clamps 20/22.

As with all embodiments shown in FIGS. 2-10, draw bolts may instead be replaced with wire, durable cord, high tensioned spring, or other resilient material that is able to provide enough tension and support to pull the diffusers and/or inlet mixers toward the centerline of the riser pipe 1. As with all embodiments shown in FIGS. 2-10, one draw bolt may attached to the clamp assemblies instead of two draw bolts (i.e., a single draw bolt may be used in either the front, the back, or the mid-plane of the jet pump assembly). Alternatively, more than two draw bolts may be attached to clamp assemblies, to apply additional lateral support and stability.

All support system components may be made by materials that are known to be acceptable for a nuclear environment. For instance, stainless steel (304, 316, XM-19, or equivalent) or nickel based alloys (Iconel, X-750, X-718, or equivalent) may be used.

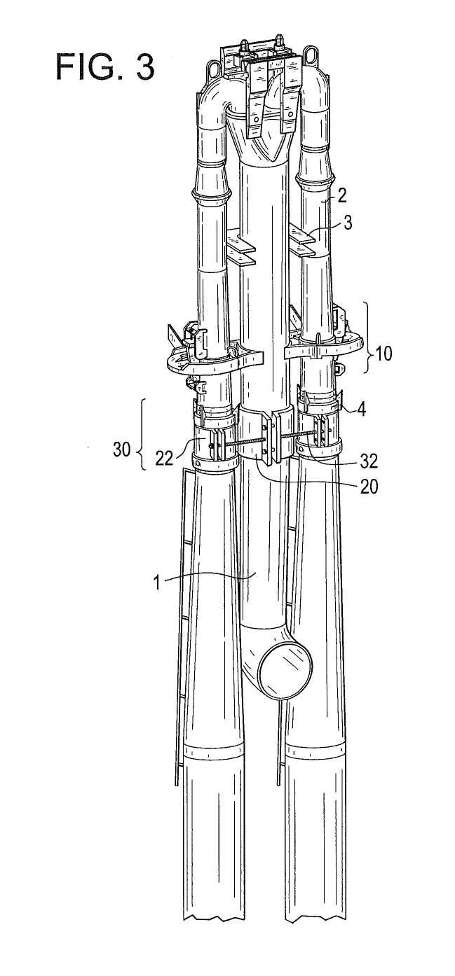

FIG. 3 is a perspective view of a BWR jet pump support system being used on a jet pump assembly, in accordance with example embodiments. The jet pump support system 30 may be fashioned on the jet pump assembly such that the diffuser clamps 22 may be clamped to the diffusers 4, and the riser pipe clamp 20 may be clamped to the riser pipe 1 in an area in between the diffusers 4. Draw bolts 32 on the front and back of the jet pump assembly help to stabilize vibratory motion of the inlet mixers 2, the diffusers 4, and the riser pipe 1. As with all of the embodiments shown in each of FIGS. 3, 5, 7, 9, and 10, draw bolts 32 should provide enough tension on the clamps that the diffusers 4 and/or inlet mixers 2 are drawn in toward the centerline of the riser pipe, or simply rigidly help in position, to mitigate vibration in the system and/or ensure that the inlet mixers stay pressed against the set screws (see for instance the set screws 11, shown in FIG. 1B) in the jet pump restrainer assemblies 10.

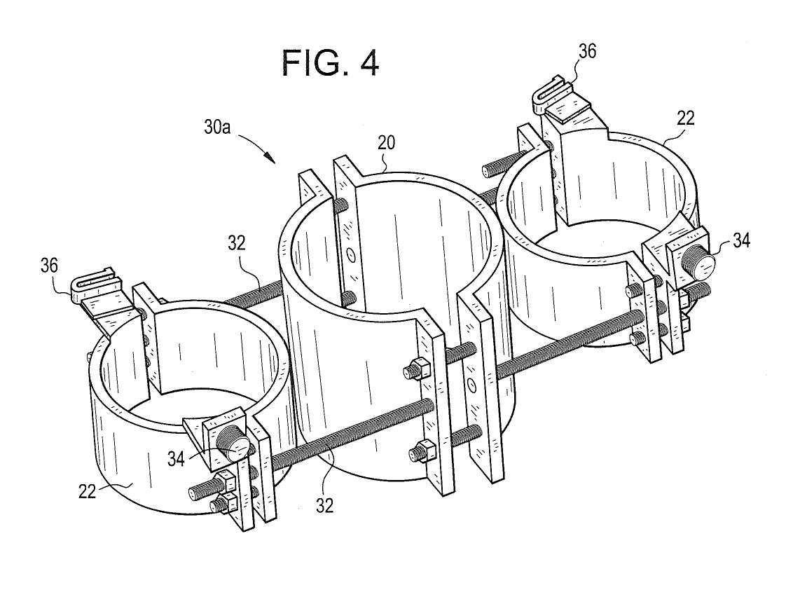

FIG. 4 is a detailed view of a BWR jet pump support system 30a with optional contact supports, in accordance with example embodiments. FIG. 4 is identical to FIG. 2, but includes optional contact supports 34/36. The contact supports may include adjustable hardstops 34 that may be used to prevent diffusers 4 and the support system 30 from rotating about the centerline of the riser pipe or contacting the reactor vessel. The hardstops 34 may be plates with threaded connections that allow an adjustment bolt to be positioned in the threaded connection in order to provide a physical stop. Alternatively, the hardstop 34 may be simply a plate or a protruding component that may prevent the diffuser 4 and support system 30 from rotating about the centerline of the riser pipe or contacting the reactor vessel. The contact supports may also include compliant stops 36 that are high tension springs that may be used to further prevent diffusers 4 and the support system 30 from contacting the core shroud that surrounds the reactor core of a BWR.

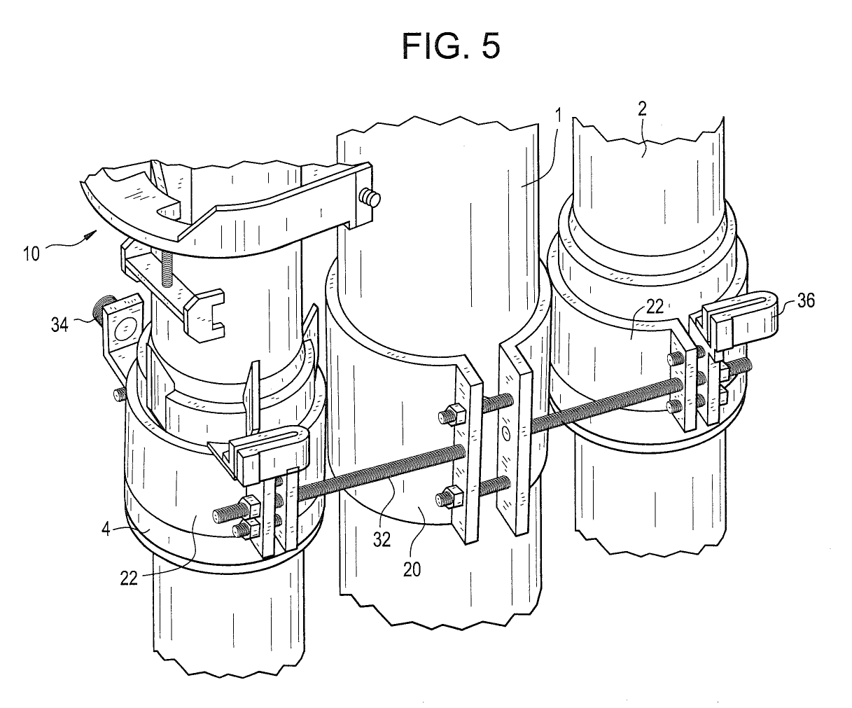

FIG. 5 is a perspective view of a BWR jet pump support system 30a with optional contact supports being used on a jet pump assembly, in accordance with example embodiments. The support system 30a is fashioned to the diffusers 4 and riser pipe 1 in the same manner as the support system 30 shown in FIG. 3, but with additional contact supports 34/36 included. The optional hardstops 34 may be included on the back side of the jet pump system, such that the hardstops 34 face the reactor vessel wall. Note that the hardstops 34 may be adjusted to contact the reactor vessel wall, prior to operation of the jet pump assembly, to mitigate vibration between the hardstops 34 and the vessel wall once the jet pumps are in operation. The optional compliant stops 36 may be included on the front side of the jet pump system, such that the compliant stops 36 face the core shroud wall when in operation.

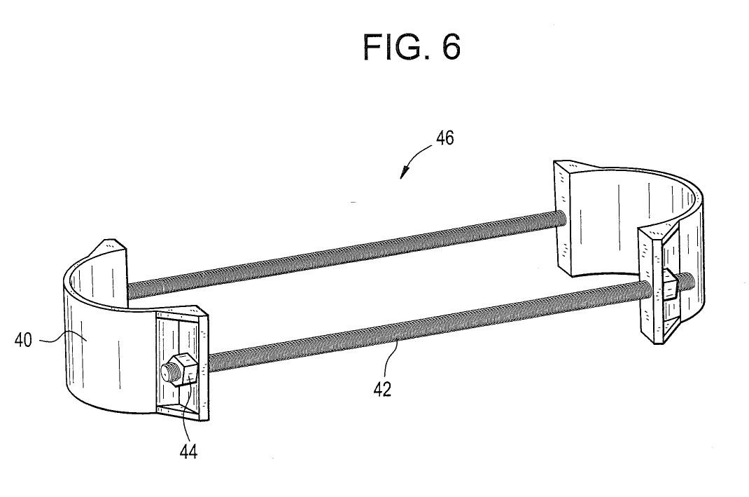

FIG. 6 is a detailed view of a simplified BWR jet pump support system 46, in accordance with example embodiments. The simplified support 46 includes diffuser clamps 40 that may be two half-collars that are sized to fit on the sides of each diffuser 4. Two draw bolts 42 may attach the two diffuser clamps 40. Alternatively, more than two draw bolts 42 may also be used. Draw bolts 42 may be affixed to the diffuser clamps 40 by providing eyelits that the draw bolts 42 may go through, and nuts 44 to fasten the draw bolts 42 in place. As described in FIG. 2, any other means of securely fastening the draw bolts 42 to the diffuser clamps 40 may also be used, such as welding, spot welding, adhesive, hooks, clamping devices, or any other means of securely fastening the bolts 42 to the diffuser clamps 40.

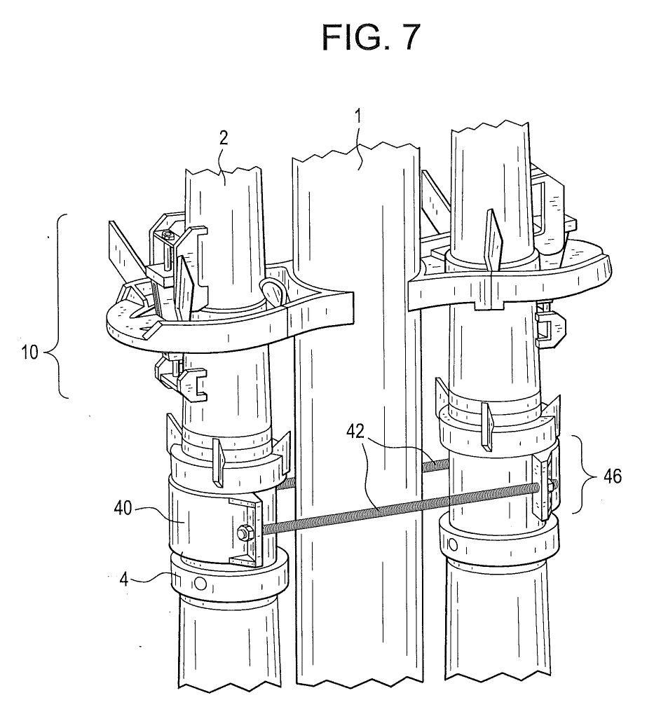

FIG. 7 is a perspective view of a simplified BWR jet pump support system 46 used on a jet pump assembly, in accordance with example embodiments. The diffuser clamps 40 are fashioned to fit around the sides of diffusers 4, and the draw bolts 42 are used to place a lateral restraining force on the diffusers 4 and pull the diffusers 4 toward the centerline of the riser pipe 1.

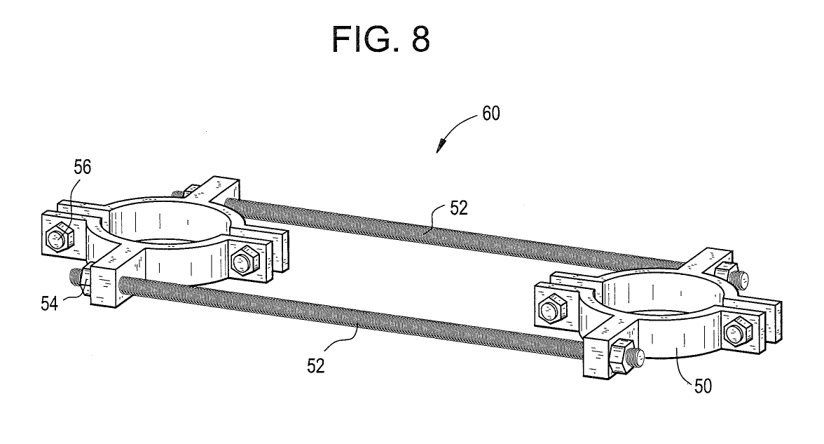

FIG. 8 is a detailed view of an optional inlet mixer support system 60, in accordance with example embodiments. The support system 60 may include inlet mixer clamps 50 that may be two half-collars held together by bolts and nuts 56, similar to the clamps shown in the other embodiments. Draw bolts 52 may again be used to connect two sets of inlet mixer clamps 50 to each other, in a manner similar to the other embodiments.

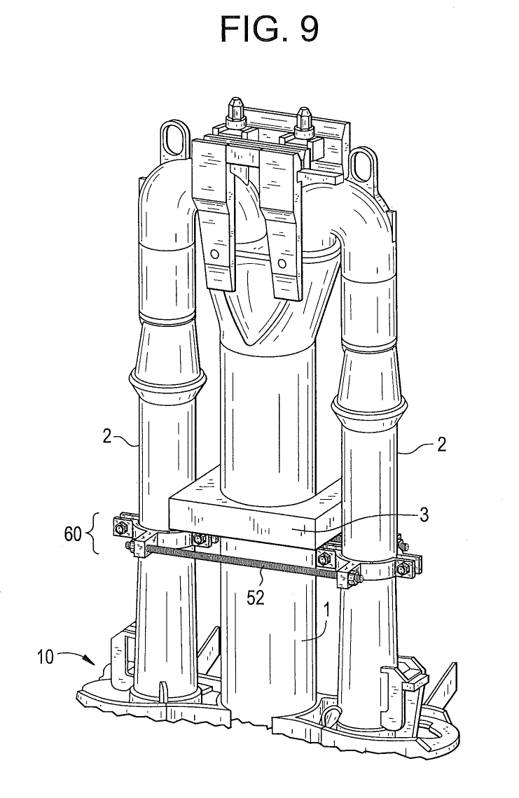

FIG. 9 is a perspective view of an optional inlet mixer support system 60 used on a jet pump assembly, in accordance with example embodiments. Notice that the support system 60 may be used on the inlet mixers 1 themselves, as opposed to the diffuser 4. Notice also that the support system 60 may be placed above the jet pump restrainer assemblies 10, and either above or below the riser brace 3 (FIG. 9 shows the support 60 just below the riser brace 3).

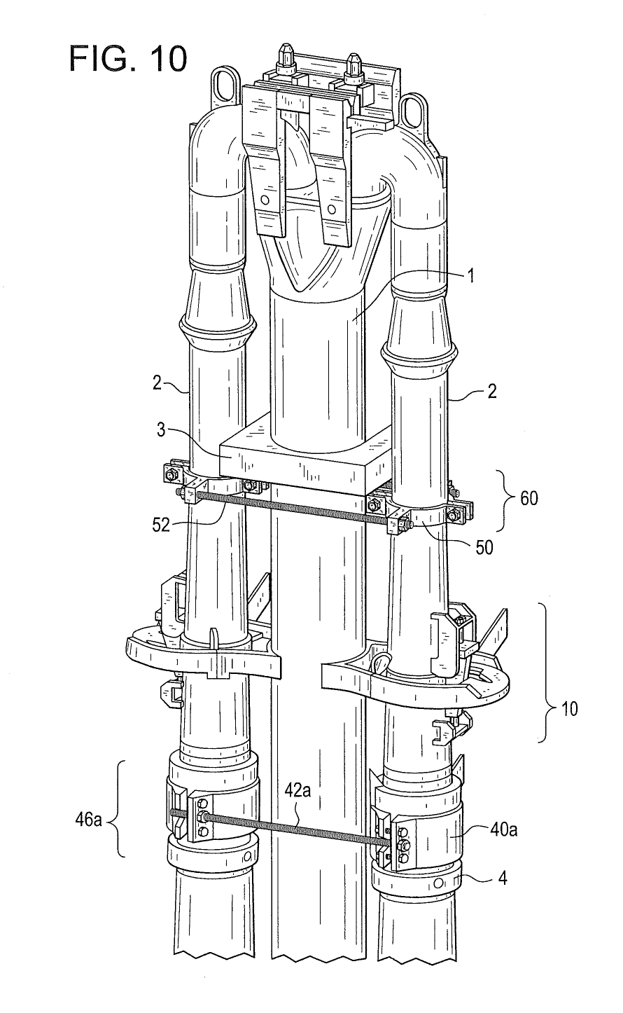

FIG. 10 is a perspective view of a BWR jet pump support system 46a and optional inlet mixer support system 60a used on a jet pump assembly, in accordance with example embodiments. In this embodiment, the inlet mixer clamp 60 is used (between the jet pump restrainers assemblies 10 and the riser brace 3) in conjunction with another simplified embodiment of a jet support system 46a attached to the diffusers 4. Alternatively, only the inlet mixer support system 60 may be used, and no jet support system 46a may be used. The jet support system 46a uses diffuser clamps 40a made from two half-cuffs, similar to the diffuser clamps 22 of FIG. 2. However, no riser clamp is used in this simplified jet support system 46a, as the draw bolts 42a attach directly to each diffuser clamp 40a, only.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. A jet pump support system for a Boiling Water Reactor (BWR) jet pump assembly, the jet pump support system comprising:
a first clamp assembly,
a second clamp assembly,
at least a first draw bolt connecting the clamp assemblies.

2. The jet pump support system of claim 1, wherein each the first and second clamp assemblies are half-cuffs with a first end and a second end.

3. The jet pump support system of claim 2, further comprising:
a second draw bolt connecting the second ends of the first and second clamp assemblies to each other, wherein the first draw bolt connects the first ends of the first and second clamp assemblies to each other.

4. The jet, pump support system of claim 3, wherein the first and second clamp assemblies have eyelits with threaded connections and the first and second draw bolts have threaded connections that mate with the eyelits, the first and second draw bolts being secured to the first and second clamp assemblies by nuts.

5. The jet pump support system of claim 1, wherein the first and second clamp assemblies each include two opposing half-cuffs, the opposing half-cuffs being held together by clamp bolts and nuts.

6. The jet pump support system of claim 1, further comprising:
a third clamp assembly located between the first and second clamp assemblies, the third clamp assembly including two opposing half-cuffs.

7. The jet pump support system of claim 6, further comprising:
a second draw bolt connecting the second clamp assembly to the third clamp assembly thereby indirectly connecting the first clamp assembly and the second clamp assembly to each other, wherein the first draw bolt connects the first clamp assembly to the third clamp assembly.

8. The jet pump support system of claim 6, wherein the first draw bolt directly connects the first clamp assembly to the second clamp assembly, the first draw bolt also being connected to the third clamp assembly, wherein at least one contact support is included on one of the first clamp assembly, the second clamp assembly, and the third clamp assembly.

9. A method of providing a lateral restraining force on a Boiling Water Reactor (BWR) jet pump assembly, the method comprising:
securing a first clamp assembly on a first diffuser or a first inlet mixer of the jet pump assembly,
securing a second clamp assembly on a second diffuser or a second inlet mixer of the jet pump assembly, and
affixing at least a first draw bolt to the first clamp assembly and the second clamp assembly to pull the first and second diffusers or the first and second inlet mixers toward a centerline of a riser pipe.

10. The method of claim 9, wherein
the first and second clamp assemblies are half-cuffs with a first and a second end,
the affixing step further including connecting the first ends of the first and second clamp assemblies to each other using the first draw bolt, and connecting the second ends of the first and second clamp assemblies to each other using a second draw bolt.

11. The method of claim 9, wherein the first and second clamp assemblies each include two opposing half-cuffs, the affixing step further including holding together the opposing half-cuffs by clamp bolts and nuts.

12. The method of claim 9, wherein the first and second clamp assemblies have eyelits with threaded connections and the first draw bolt and a second draw bolt has threaded connections that mate with the eyelits, the affixing step further including securing the first and second draw bolts to the first and second clamp assemblies using nuts.

13. The method of claim 9, wherein the securing of the first clamp assembly includes securing the first clamp assembly on the first diffuser, wherein the securing of the second clamp assembly includes securing the second clamp assembly to the second diffuser, the method further comprising:
securing a third clamp assembly to the first inlet mixer,
securing a fourth clamp assembly to the second inlet mixer, and
affixing a second draw bolt to the third clamp assembly and the fourth clamp assembly to pull the first and second inlet mixers toward a centerline of a riser pipe.

14. The method of claim 13, wherein the securing of the third clamp assembly and the fourth clamp assembly includes securing the third and fourth clamp assemblies to the inlet mixer in a position between a jet pump restrainer assembly and a riser brace.

15. The method of claim 9, wherein the affixing step includes the first draw bolt providing enough tension on the diffusers that the inlet mixers are pressed against a pair of set screws in a jet pump restrainer bracket.

16. A method of providing a lateral restraining force on a Boiling Water Reactor (BWR) jet pump assembly, the method comprising:
securing a first clamp assembly on a first diffuser or a first inlet mixer of the jet pump assembly,
securing a second clamp assembly on a second diffuser or a second inlet mixer of the jet pump assembly.
securing a third clamp assembly on a riser pipe, the third clamp assembly including two opposing half-cuffs, and
affixing at least a first draw bolt to the first clamp assembly and the second clamp assembly to pull the first and second diffusers or the first and second inlet mixers toward a centerline of a riser pipe.

17. The method of claim 16, further comprising:
connecting the first clamp assembly to the third clamp assembly using the first draw bolt, and
connecting the second clamp assembly to the third clamp assembly using a second draw bolt thereby indirectly connecting the first clamp assembly and the second clamp assembly to each other.

18. The method of claim 16, further comprising:
affixing the first draw bolt to the third clamp assembly.

19. The method of claim 16, wherein the securing of the first clamp assembly includes securing the first clamp assembly to the first diffuser, wherein the securing of the second clamp assembly includes securing the second clamp assembly to the second diffuser, the method further comprising:
securing a fourth clamp assembly to the first inlet mixer,
securing a fifth clamp assembly to the second inlet mixer,
securing a sixth clamp assembly to the riser pipe, and
affixing a second draw bolt to the fourth clamp assembly and the fifth clamp assembly to pull the first and second inlet mixers toward a centerline of a riser pipe.

20. The method of claim 19, wherein the securing of the fourth clamp assembly, the fifth clamp assembly and the sixth clamp assembly includes securing the fourth and fifth clamp assemblies to the first and second Inlet mixers in a position between a let pump restrainer assembly and a riser brace, and securing the sixth clamp assembly to the riser pipe in a position between the jet pump restrainer assembly and the riser brace.

21. The method of claim 16, wherein the securing of the first and second clamp assemblies includes securing the first and second clamp assemblies to the first and second diffusers, respectively, and the affixing step includes the first draw bolt providing enough tension on the diffusers that the inlet mixers are pressed against a pair of set screws in a jet pump restrainer bracket.
